(19) United States
(12) Patent Application Publication
(10) Pub. No.: US 2011/0259080 A1
(43) Pub. Date: Oct. 27, 2011

(54) GAS SENSOR

(75) Inventors: Norman Mark Ratcliffe, Bristol (GB); Ben De Lacy Costello, Bristol (GB); Mary Winifred Richards, Bristol (GB)

(73) Assignee: University of the West of England, Bristol, Bristol (GB)

(21) Appl. No.: 12/679,151

(22) PCT Filed: Sep. 17, 2008
(86) PCT No.: PCT/EP08/62391

§ 371 Date: Oct. 15, 2010

(30) Foreign Application Priority Data
Sep. 19, 2007 (GB) 0718299.1

(51) Int. Cl. G01N 30/02; B05D 1/02; B05D 3/00; G01N 7/00; B05D 5/00

(52) U.S. Cl. 73/23.35; 73/31.05; 427/126.3

(57) ABSTRACT

A method of detection of a volatile compound in a gaseous atmosphere comprises irradiating a semiconducting metal oxide material with ultraviolet light, exposing the irradiated material to the gaseous atmosphere and determining the presence of any volatile compound in the atmosphere by monitoring a change in electrical conductivity of the material. The method can detect non-polar organic compounds as well as polar compounds. Zinc oxide particles in the nanometre size range are preferred. The method may be used for medical diagnosis or for environment monitoring purposes.

This invention relates to gas sensors of the metal oxide type and especially, but not exclusively, provides a portable gas sensor which will react to a broad range of both polar and non-polar gases and which does not require activation by heating.

Conventional gas sensors based on heated metal oxide semiconductor materials which are capable of reversibly altering their electrical resistance in the presence of volatile compounds, including volatile organic compounds (VOCs) are known. Such sensors may be used especially for the detection of non-polar gaseous organic compounds such as hydrocarbons, although they are usually more sensitive to polar compounds such as ethanol. Nevertheless, they are sufficiently responsive to non-polar compounds to enable them to be used in warning devices for leak detection of flammable gases. The commercial devices generally require mains electricity for extended periods of operation, since it is necessary to maintain the temperature of the substrate at around 300° C.

More recently, it has been shown that ultraviolet (UV) light can be used to enhance the sensitivity of semiconducting materials towards VOCs, at ambient temperatures. Such semiconductor materials are described as being polycrystalline in nature, the materials being thermally treated so that the metal oxide grains are connected to each other either by grain boundaries or by necks. It is believed that, when UV radiation is incident on the metal oxide films, the inter-grain conductivity is increased by a modification of the surface potential.

WO2006/088477 describes a gas sensor comprising a semiconducting substrate coupled to electrodes with a source of narrowband radiation directed at the substrate. The sensor operates at room temperature and, because the radiation is narrowband and has a mean energy less than the bandgap energy of the substrate, gases can be selectively sensed. Semiconductors suitable for the substrate include organic and inorganic semiconductors and semiconductors including both organic and inorganic components.

According to the present invention, we provide a method for detection of one or more volatile compounds in a gaseous atmosphere, the method comprising irradiating a semiconducting metal oxide material with ultraviolet light, exposing the irradiated material to the gaseous atmosphere and determining the presence of any volatile compound in the atmosphere by monitoring a change in electrical conductivity of the material.

In the present invention, the volatile compound may be inorganic or organic.

In the method according to the invention, the ultraviolet light preferably has a wavelength in the range 360-400 nm, that is close to (at the high end of the range) visible light. Conveniently, UV-LEDs may be used as the source of activating UV light for the sensor, since they emit in the preferred range and, being small, enable the invention to be performed with portable apparatus. Beneficially, certain UV-LEDs which can focus the emitted UV onto the surface of the semi-conductor via an integral lens may be used.

The metal oxide material may comprise a mixture of two or more metal oxides.

An advantage of the method of the invention is that, since UV activation takes place at ambient room temperature, no heating of the metal oxide material is required and the overall energy requirement is thus kept to a minimum. The method is also thus suitable for use in flammable atmospheres.

Preferably, the metal oxide material is granular and is carried on a suitable support or carrier material.

In the method according to the invention, the metal oxide is preferably selected from Groups IVA, VIA, VIII (except the noble metals of that group), IIB and IIIB of the Periodic Table. Particularly preferred metal oxides are selected from one or more of the oxides of tin, indium, zinc, tungsten, chromium, titanium, nickel, cadmium and iron. Of these, it is especially preferred to use tin oxide, indium oxide and/or zinc oxide, especially zinc oxide. Complex oxides such as indium tin oxide or perovskites may be used, and the oxide or mixture of oxides may originally include other metals as dopants, to change the bandgap.

It has surprisingly been found that, in the method according to the present invention, volatile compounds which can be detected in gaseous form include both polar and non-polar compounds. This marks a particular difference compared with conventional metal oxide sensors, which do not exhibit high sensitivity to non-polar compounds such as methane, propane and other hydrocarbons. Additionally, it has also surprisingly been found possible to distinguish between different members of the same homologous series of compounds; for example, the method according to the invention gives differential responses to certain hydrocarbons. The method according to the present invention has particular application in terms of medical diagnostics, being able to detect compounds such as acetone, acetaldehyde and pentane when in the vapour state, which compounds are known to be potential indicators of disease or of well-being and are present in body fluids including breath and vapours emitted, for example, by stool, urine, blood and sputum. For example, increased levels of breath acetone are indicative of diabetes mellitus and increased levels of pentane in breath have been linked to increased oxidative stress in diseases such as cancer, arthritis and during myocardial infarction. The method may also be used for environmental monitoring of an ambient atmosphere, particularly with the aid of portable handheld instruments. Potential gases to be detected include methane, ozone, hydrogen sulphide, carbon monoxide, petroleum, paraffin, jet fuel hydrogen and NOx. Safety monitoring of an ambient atmosphere in the workplace or in connection with industrial processes is another potential application. Many of these situations involve explosive gases and highly inflammable volatiles where sensors requiring high temperature activation are not applicable. Such monitoring represents a further application of the invention. In the context of the method of the invention, an ambient atmosphere may be the atmosphere in a general geographical area or in a localised area such as a factory, laboratory, aircraft or other building, room or transit container.

Semiconducting metal oxides have been found to develop sensitivity to volatile compounds after activation by irradiation with ultraviolet light. Before irradiation, the metal oxide has a high electrical resistance and is insensitive to high concentrations of various volatile compounds, high concentrations in this context meaning in general concentrations of greater than 1000 ppm, whereas, on or following irradiation by ultraviolet light, typically the electrical resistance initially falls substantially and thereafter reaches a steady state value, after which the material is activated and exhibits extremely high sensitivity to a wide range of volatile compounds. The irradiation may be continuous over the period of activation, or pulsed for the purpose of saving power.

The response of semiconducting metal oxides, when irradiated by ultraviolet light, to different gaseous compounds can be characteristic of the compound in terms of resistance change with time, thereby enabling the output to be used for qualitative analytical purposes, that is, to determine the nature of the compound as well as the mere presence or absence of a volatile compound. However, in order to enhance the qualitative analytical capabilities of the method of the invention, gas chromatography may be used in combination with the semiconducting metal oxide detection method, whereby the chromatography will provide the means to distinguish between and identify different volatile compounds the presence of which in more non-specific terms has been identified by the metal oxide. In using gas chromatography in combination, one or more of the same or different metal oxide or other sensors may be used with one or more chromatography columns, for example with the sensors disposed at the downstream end of the column or columns. The identification both of individual compounds and mixtures thereof, for example by analysis of gas chromatography retention times with changes in sensor response, can as a result be considerably enhanced.

In another aspect, the present invention provides a gas sensor comprising a metal oxide, preferably in particulate form and supported on a substrate, irradiated with ultraviolet light. An array comprising at least one metal oxide sensor may be provided, with one or more sensors of another type.

Where the metal oxide is granular, the particle size thereof for use in the present invention is for most purposes preferably lmicron or less and may be in the nanoparticulate range, for example between 10 and 250 nm, especially where high sensitivity is required, or more preferably from 50 to 100 nm or even 50 to 70 nm. The supporting substrate is preferably an electrode to the surface of which a composition including the metal oxide powder is applied preferably as a finely-ground dispersion in a suitable liquid carrier, forming a material having the consistency of a paste. Having been applied to the substrate surface, the paste is allowed to dry in air. However, the metal oxide may in other instances comprise a continuous film or layer applied to a suitable carrier substrate. The composition may be applied to the substrate by screen printing or by inkjet printing, for example, to define a semiconducting pathway having lands at the ends for attachment of electrical connections to a voltage source.

The gas sensor including the dried dispersion or layer of metal oxide is connected to a voltage source of for example up to 12 volts, 9 volts being typical, the change in current in response to the presence of volatile compounds being monitored for example via a scanner and electrometer and connected through a suitable interface to a computer. The temperature and humidity data may also be recorded. The sensors are disposed in proximity to the source of ultraviolet light, typically a UV-LED positioned directly over the sensor surface preferably at a spacing of 5 mm or less, more preferably less than 1 mm. The intensity of the UV-LEDs may be monitored using photodiodes.

For detection of certain volatile compounds, especially compounds such as hydrocarbons in high-humidity environments, it has been found advantageous to reduce the applied voltage to 5 volts or less, preferably even less than 1 volt, for example 0.1 volt.

In use, the UV intensity is set to an optimum value and the sensor surface is exposed to the UV radiation while the voltage is applied to the sensor and the current monitored over time. Once the current has stabilised, and sensitivity has optimised, the sensor can be exposed to volatile compounds the presence of which is detected by virtue of a change in current.

Use of the invention has enabled a rapid response especially to the presence of VOCs to be obtained, typically within one minute for concentrations in the sub-ppm levels, with reversible changes in electrical resistance when exposed to vapours including hydrocarbons (for example, methane, propane, butane, pentane, hexane, isoprene), alcohols (for example, methanol, ethanol, butanol, isopropanol), esters (for example, ethyl acetate), ketones (for example, acetone), aldehydes (for example, acetaldehyde), aromatic compounds (for example, toluene) and carbon monoxide. In particular, it has been found that sensors according to the invention are highly sensitive to saturated hydrocarbons, especially methane and propane, compared with conventional metal oxide sensors, as well as being sensitive to polar compounds such as alcohols. Additionally, it has been found that the response is different for different classes of compounds; for example, saturated hydrocarbons cause a rapid increase in electrical resistance of the sensor whereas alcohols cause a rapid decrease in resistance followed by an increase in resistance, followed eventually by recovery to the original baseline resistance. It also appears that different volatile compounds within the same chemical class, such as hydrocarbons, will give different response characteristics, raising the possibility of the method of the invention being usable to distinguish between target compounds and interfering volatiles using only one sensor, in that different compounds have different “fingerprint” responses.

The highest overall sensitivity to date has been observed using zinc oxide nanoparticulates, for example between 10 and 250 nm, as the metal oxide. It is postulated that this is because of the close match between the peak wavelength of UV-LEDs (typically around 390 nm) and the equivalent known wavelength for the bandgap of zinc oxide, resulting in semiconducting properties. For other metal oxides, therefore, the peak wavelength of the ultraviolet light should preferably be similar to that of the bandgap of the oxides, where possible. For a given metal oxide material, it has been found that finer nanoparticulates provide the highest sensitivity to volatile compounds. Detection limits as low as 1 ppb have been realised for some volatile compounds, including some compounds which, according to the literature, are conventionally difficult to detect even at ppm levels. Other metal oxides may yield optimal results following irradiation at other wavelengths in the UV range, and sensitivity for a given metal oxide may be influenced by the choice of irradiation wavelength.

Parameters which affect sensor performance and are inter-related are particle size of the metal, for example zinc, oxide, the wavelength of the ultraviolet radiation and the intensity of the radiation. Generally, the particle size should preferably be from 50 to 70 nm, for example 60 nm; wavelength should be from 360 to 400 nm, preferably 390 to 400 nm and more preferably 395 to 400 nm, and the intensity should be from 0.001-50, preferably 1-10, more preferably 2-5, for example around 3 mW/cm². The use of two or more sensors operating at respectively different intensities would advantageously enable the method of the invention to be used more effectively to discriminate between different volatile compounds.

Embodiments of the invention will now be described by way of example with reference to the accompanying figures, of which:

FIG. 1 shows the response of a zinc oxide nanoparticulate sensor to ethanol and various hydrocarbons;

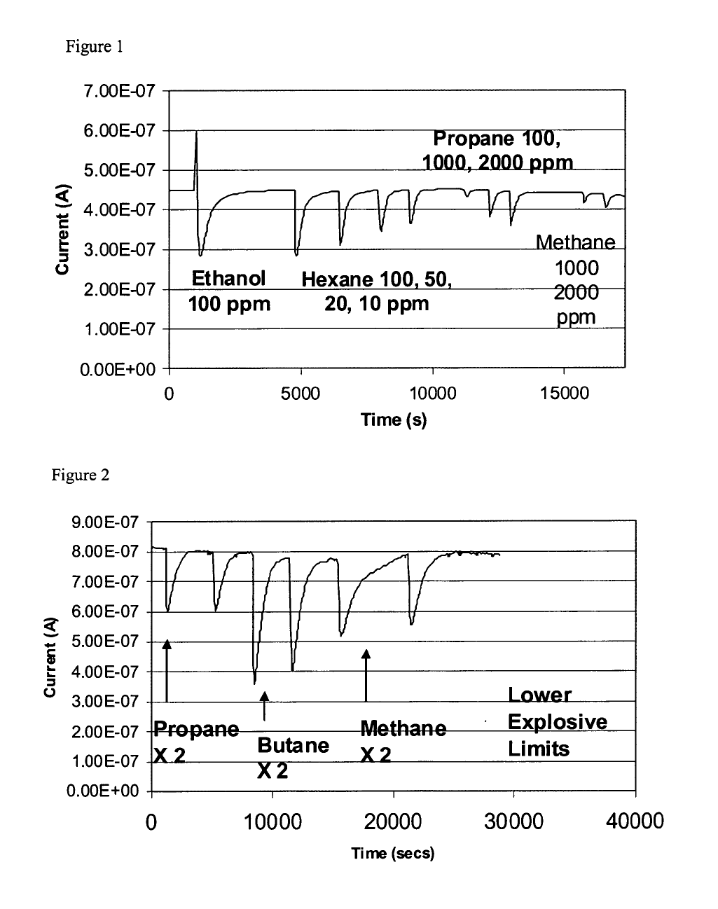

FIG. 2 shows the response of a zinc oxide nanoparticulate sensor to flammable gases at the lower explosive limits;

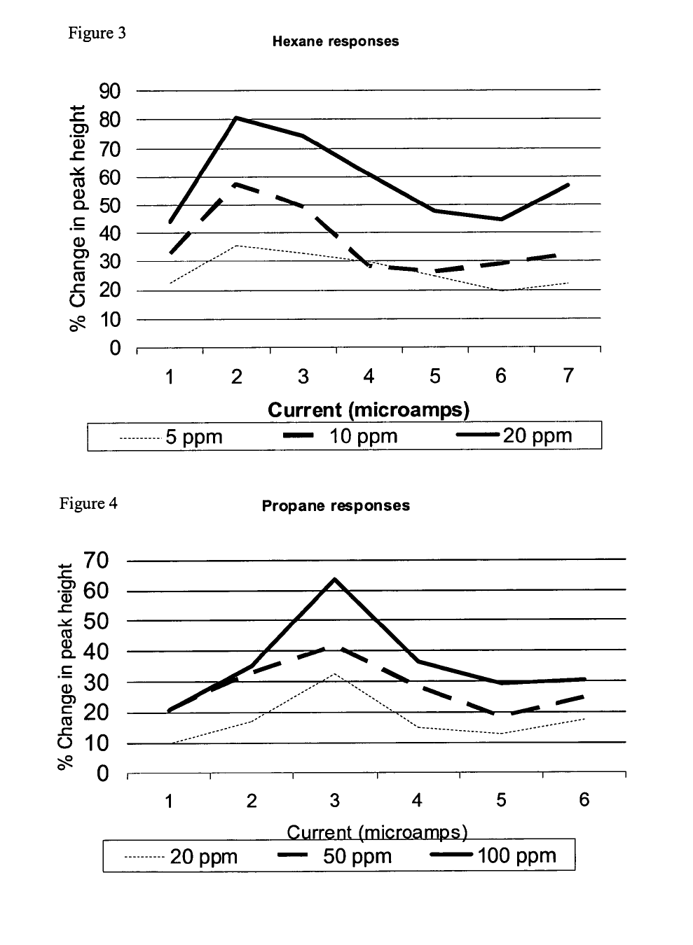

FIG. 3 shows the effect of varying the UV light intensity on the response to exposure to hexane;

FIG. 4 is similar to FIG. 3 but uses propane instead of hexane;

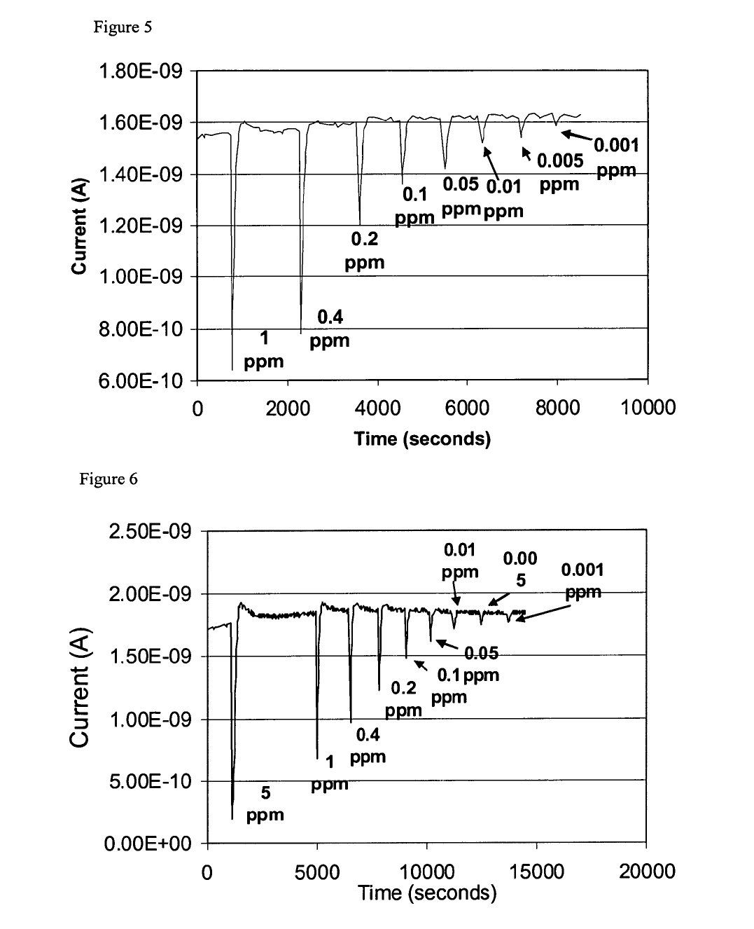

FIG. 5 shows the response of a zinc oxide nanoparticulate sensor to acetaldehyde at various concentrations;

FIG. 6 shows the response of a zinc oxide nanoparticulate sensor to acetone at various concentrations;

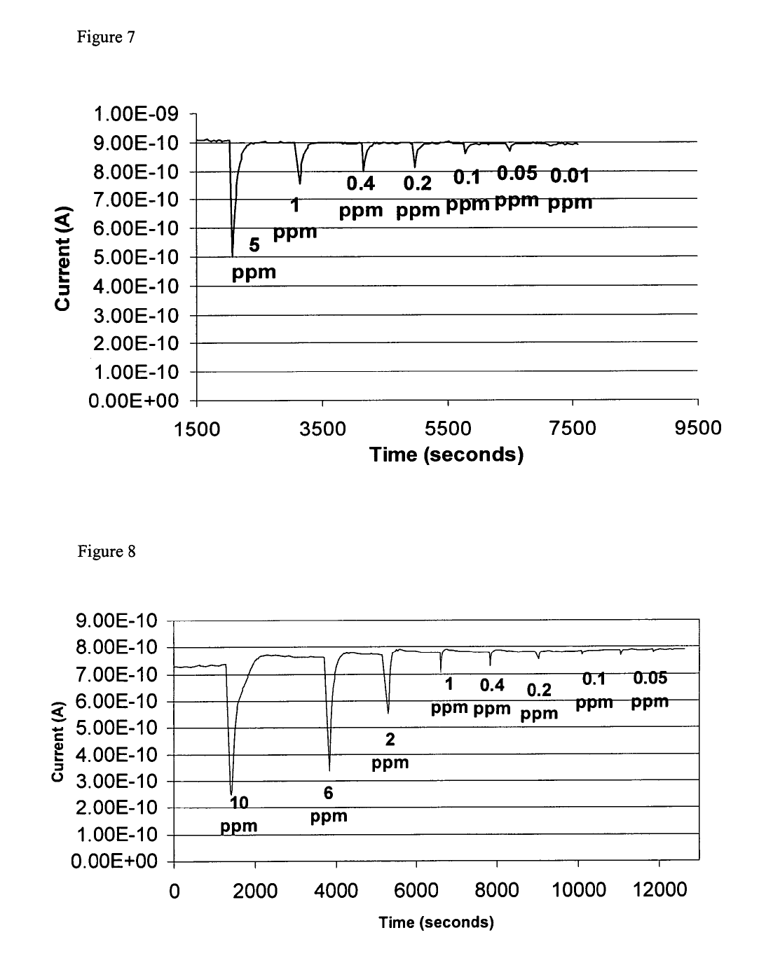

FIG. 7 shows the response of a zinc oxide nanoparticulate sensor to pentane at various concentrations;

FIG. 8 shows the response of a zinc oxide nanoparticulate sensor to toluene at various concentrations; and

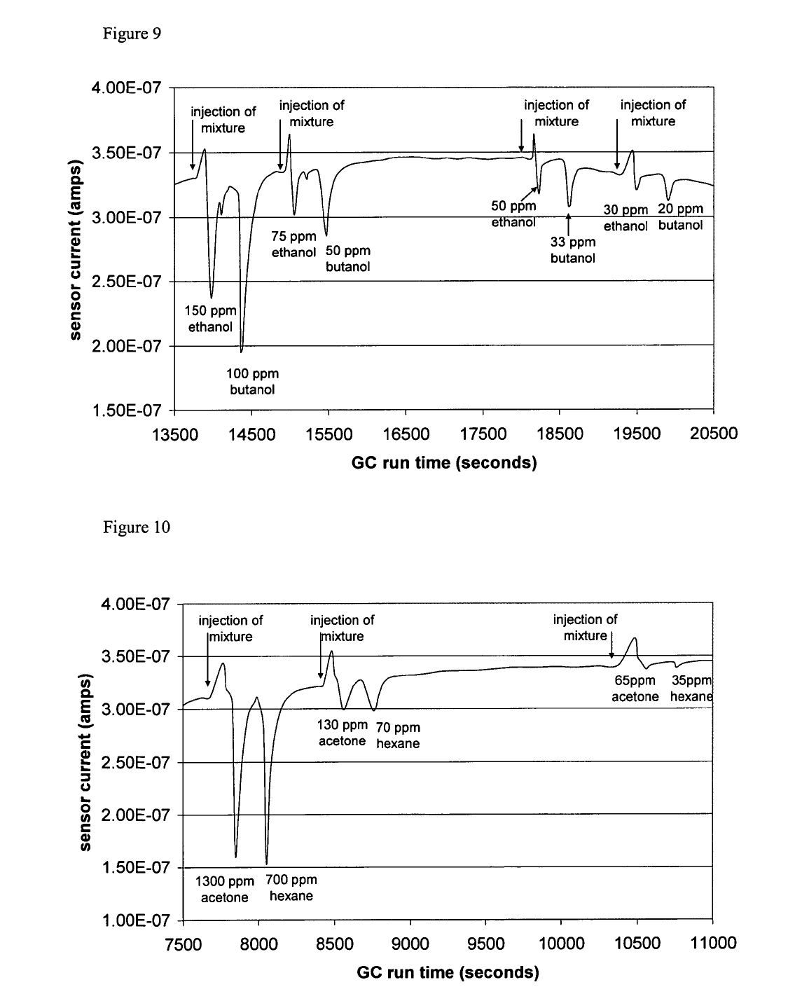

FIG. 9 shows the resolution of a mixture of hexane and acetone achieved from a zinc oxide nanoparticulate sensor in combination with a gas chromatography column;

FIG. 10 shows the resolution of a mixture of ethanol and butanol achieved from zinc oxide nanoparticulate sensor in combination with a gas chromatography column; and

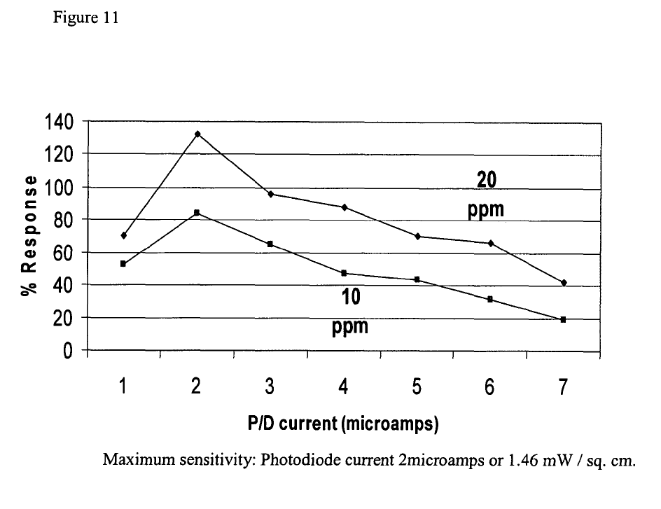

FIG. 11 shows a graph of sensitivity of fine zinc oxide nanoparticulates to ethanol vs light intensity at two concentrations.

With reference firstly to FIG. 1, it is seen how the response to ethanol is qualitatively different from the response to saturated hydrocarbons and, furthermore, that, for a given hydrocarbon, the response both in terms of response time and peak height varies with concentration. Thus, the method according to the invention can be used to discriminate not only between different hydrocarbons in the same class (alkanes) but also to provide an indication of the concentration of a given alkane.

With reference to FIG. 2, the method according to the invention using a zinc oxide nanoparticulate sensor was tested with different alkanes at the lower explosive limits thereof and the results show a large and rapid change in electrical resistance which, after purging with dry air, is gradually reversible to essentially the same baseline current. It has also been found that a significant change in current occurs when testing the same hydrocarbons at 100% humidity. It is therefore apparent that, especially because this type of sensor consumes low power, the invention could be applied to provide a battery-operated flammable gas detector for domestic and leisure use.

FIGS. 3 and 4 illustrate the effect of changing the UV intensity on the sensitivity of the sensor. Light intensities between 0.36 and 22 mW/cm² were tested and it was found that the optimum light intensity for hexane vapour (FIG. 3) was 1.46 mW/cm² and for propane vapour (FIG. 4) was 2.2 mW/cm², the current measured being from the photodiodes where 1 microamp is equivalent to 0.733 mW/cm². The particle size of the zinc oxide was from 90-210 nm. However, using zinc oxide giving a particle size of 60 nm, the optimum intensities have been found to be 2.9 for propane and 3.7 for hexane. For methane, the optimum intensity for the 60 nm particles was 2.2 and for ethanol 1.5 mW/cm². The optimum light intensities are well within the capabilities for UV-LEDs. In addition, FIGS. 3 and 4 show that the optimum light intensity is independent of concentration, although the percent change in the peak height is concentration-dependent. Thus operation of a UV sensor at an intensity value of 1.5 mW/cm² by exposure to the same concentration of hexane and ethanol (in sequence) would result in a higher response to ethanol (ratio of response 1.3 times more sensitive to ethanol). A repeated operation with the sensor irradiated with a higher light intensity of 3.7 mW/cm² would result in a much higher relative response to hexane than to ethanol. In this case the sensor was 3.5 times more sensitive to hexane than to ethanol. It has also been found that the wavelength can alter the selectivity of the sensors and in some cases even change the direction of response to certain vapours especially at very specific wavelengths.

With reference to FIGS. 5 and 6, acetaldehyde (FIG. 5) and acetone (FIG. 6) were tested over a range of concentrations from ppm to ppb levels. It was observed that especially the fine zinc oxide nanoparticulate powders in the size range 50-70 nm exhibited very high sensitivity even at concentrations as low as 1 ppb, such sensitivity comparing very favourably with conventional metal oxide sensors. Such high sensitivity to a wide range of volatile compounds enables sensors according to the invention to be used as universal detectors in conjunction with conventional or micro gas chromatography columns. In particular, the invention has application in the field of medical diagnostics, since compounds shown to be detectable are known to be medically significant markers of disease and, for example, the separation and detection of complex matrices of volatile compounds from medical samples, particularly breath samples, is potentially of great interest.

With reference to FIGS. 7 and 8, pentane and toluene were respectively tested over a range of concentrations at ppm levels, and showed sensitivity at concentrations down to 0.05 ppm.

With reference to FIG. 9, 2 ml of various concentrations of hexane and acetone were injected into a GC system operated at an isothermal temperature with air as the carrier gas at three different time points. The detector placed at the end of the GC column was a UV LED activated zinc oxide nanoparticulate sensor.

With reference to FIG. 10, 2 ml of various concentrations of ethanol and butanol were injected into a GC system under the same conditions as for FIG. 9.

With reference to FIG. 11, the light intensity of the LED was monitored using a photodiode. In experiments to determine the optimum light intensity for specific volatiles, ethanol in this instance, a low intensity of 0.36 mW/cm² was set according to the photodiode (light intensity is related to measured current from the photodiode). The sensors were then tested for a range of volatile compounds including ethanol and hexane at different concentration levels. The sensitivity values for the sensors to each volatile were calculated. At the end of each day, the LED was set to a higher intensity value and the sensors were left to equilibrate overnight. The following day, the sensor tests with the same volatiles/concentrations were repeated at higher light intensity value. This process was continued until the maximum intensity of the LED was reached. By working out the relative responses on each day, a relationship between sensitivity and light intensity could be established for a range of volatiles.

The responses achieved from these experiments were compared with a flame ionisation detector (FID) and a conventional heated ceramic sensor. The UV LED activated detector exhibited higher sensitivity to hexane than either the FID or heated ceramic sensor (proved by serial dilution of the mixture).

The invention also includes, in another aspect, a method of diagnosis of a disease state in a patient, in which the patient provides a body fluid sample the vapour from which is subject to a method as hereinbefore described and the presence in the sample of one or more medically significant disease markers is determined. The method may comprise the steps of collecting a sample of fluid emission from a body and analysing volatile compounds contained in the emission for the presence or absence of at least one volatile compound, wherein the presence or absence of at least one volatile compound is indicative of a disease state, to determine the presence or absence of said disease state in said body. The fluid emission may be collected and subsequently sorbed, for example by use of a solid or liquid sorbent, and de-sorbed prior to analysis at a later date.

Additionally, the apparatus and method may be employed to identify one or more volatile compounds or patterns thereof that are indicative of a disease state by analysing the volatile compounds contained in an emission from a body of at least one patient with a given disease, for example lung cancer, and comparing these with the volatile compounds from a body of at least one patient without the given disease state. The so identified volatile compounds or patterns thereof can subsequently be used to determine the presence or absence of disease in other patients by analysing their fluid emissions for the presence or absence of these volatile compounds

1. A method for detection of one or more volatile compounds in a gaseous atmosphere, the method comprising irradiating a semiconducting metal oxide material with ultraviolet light, exposing the irradiated material to the gaseous atmosphere and determining the presence of any volatile compound in the atmosphere by monitoring a change in electrical conductivity of the material.

2. A method according to claim 1, in which the ultraviolet light has a wavelength in the range 360-400 nm.

3. A method according to claim 1 or claim 2, in which UV-LEDs are used as the source of activating ultraviolet light for the sensor.

4. A method according to any preceding claim, in which the metal oxide material comprises a mixture of two or more metal oxides, and/or is granular and is carried on a support or carrier material.

5. A method according to any preceding claim, in which the metal oxide is an oxide of a metal selected from Groups IVA, VIA, VIII (except the noble metals of that group), IIB and IIIB of the Periodic Table.

6. A method according to claim 5, in which the metal oxide is selected from tin oxide, indium oxide and/or zinc oxide.

7. A method according to any preceding claim, in which the resistance change with time is monitored.

8. A method according to any preceding claim, in which the volatile compounds include non-polar compounds.

9. A method according to any preceding claim, in which different members of the same homologous series of compounds are detected and distinguished from each other.

10. A method according to any preceding claim, in which the irradiation is applied in pulsed form.

11. A method according to any preceding claim, including the use of gas chromatography in combination with the semiconducting metal oxide detection method, whereby the chromatography provides the means to distinguish between and identify different volatile compounds the presence of which in more non-specific terms has been identified by the metal oxide.

12. A method according to claim 11, in which one or more of the same or different metal oxide or other sensors is used with one or more chromatography columns.

13. A gas sensor comprising a metal oxide in particulate form and supported on a substrate, for irradiation with ultraviolet light in a method according to any of claims 1 to 12.

14. An array of gas sensors according to claim 13, the array comprising at least one metal oxide sensor optionally together with a sensor of another type.

15. A gas sensor according to claim 13 or claim 14, in which the metal oxide is granular, the particle size thereof being 1 micron or less, for example in the nanoparticulate range.

16. A gas sensor according to any of claims 13 to 15, in which the metal oxide is zinc oxide having a particle size of 50-70 nm.

17. A method of manufacture of a gas sensor according to any of claims 13 to 16, in which the metal oxide in powder form is applied to an electrode surface as a finely-ground dispersion in a liquid carrier, the dispersion being allowed to dry in air.

18. A method according to claim 17, in which the metal oxide is contained in a composition which is applied to a substrate by screen printing or by ink jet printing.

19. A method of diagnosis of a disease state in a patient, in which the vapour from a body fluid sample is subject to a detection method according to any of claims 1 to 12 to determine the presence or absence in the sample of one or more volatile compounds as medically significant disease markers.

20. A method of identifying markers of disease, in which one or more volatile compounds or patterns thereof that are indicative of a disease state are identified by analysing the volatile compounds contained in an emission from a body of at least one patient with a given disease and comparing said compound or compounds with the volatile compound or compounds from a body of at least one patient without the given disease state, and subsequently using said identified volatile compounds or patterns thereof to determine the presence or absence of disease in other patients by analysing their fluid emissions for the presence or absence of said volatile compounds.

21. A method of environmental or safety monitoring, in which a sample of ambient atmosphere is subject to a detection method according to any of claims 1 to 12 to determine the presence in the sample of one or more volatile compounds as pollutants or hazardous materials.

22. A method according to any of claims 19 to 21, in which the metal oxide material is disposed on a substrate contained in a portable handheld instrument.
